(19) United States
(12) Patent Application Publication
(10) Pub. No.: US 2009/0078084 A1
(43) Pub. Date: Mar. 26, 2009

(54) Boot Cover Assembly

(76) Inventor: Richard Alfred Compau, Holly, MI (US)

Correspondence Address: GKN DRIVELINE NORTH AMERICA, INC, 3300 UNIVERSITY DRIVE, AUBURN HILLS, MI, 48326, US

(21) Appl. No.: 11/859,242

(22) Filed: Sep. 21, 2007

(51) Int. Cl. F16J 15/52; G05G 25/00

(52) U.S. Cl. 74/608; 277/636

(57) ABSTRACT

A boot cover assembly includes a generally cylindrical axially extending can, and a generally conical axially extending boot. The can has a first end, a central portion, and a second end. The boot includes inner and outer surfaces, a first large end, a central portion, a second small end. A portion of the second end of the can and a portion of the first large end of the boot are bonded together to form a coupling region. A portion of the inner surface of the second end of the can is bonded to a mounting face formed on an inner surface of the boot. A distal end of the can is also bonded to a mounting shoulder of the boot such that two surfaces of the can are secured to two surfaces of the boot.

### TECHNICAL FIELD

The present disclosure relates to a sealing assembly and, more particularly, to boot cover assembly typically used with a constant velocity joint.

### BACKGROUND

Constant velocity joints and similar rotating couplings typically include a boot cover assembly and grease cover to enclose and protect the coupling during operation. Since the boot cover assembly is partially flexible, the boot cover assembly is able to seal around the joint while permitting articulation and relative axial movement of differing rotating members of the joint. The boot cover assembly seal lubricant in the joint so as to reduce friction and extend the life of the joint. The boot cover assembly also seal out dirt, water and other contaminants to protect the functionality of the joint. However, leaks may reduce the life of the joint, and contaminants in the grease may disturb the chemical composition of the grease, degrading its performance.

An important characteristic of the constant velocity joint is the ability of the joint to allow relative axial movement between two shafts while maintaining a seal to the outside environment. Examples of known joint assemblies are disclosed in commonly-owned U.S. Pat. Nos. 6,817,950, 6,776,720, 6,533,669 and 6,368,224, and U.S. Pat. No. 5,899,814, the disclosures of which are hereby incorporated by reference in their entireties.

Constant velocity joints require constant lubrication (grease) to remain in operation in the environment in which they are utilized. They typically use a sealed system to contain the grease, the main component of which is the boot and associated mounting can. Boots come in a variety of types. Some examples include: convoluted, internal rolling diaphragm (IRD) and external rolling diaphragm (ERD). Particularly relating to IRD and ERD boots, the current industry standard is to have the diaphragm boot crimped onto the mounting can, and then to have the mounting can fit onto the joint. The mounting can and boot are crimped together at the top only, which allows grease that is under pressure from centrifugal forces during the joint rotation to be pushed between the sides of the boot and the mounting can. The grease build-up causes bulging and distortion during high-speed operation, thereby weakening the boot. In some cases the distortion may be excessive and lead to a complete failure of the boot cover assemblies of the prior art by decoupling the boot from the mounting can.

What is needed, therefore, is a boot cover assembly that provides increased resistance to decoupling during normal operation from bulging grease, accommodates greater axial extension and relative angles within a joint assembly, and produces a more reliable boot cover assembly.

### SUMMARY OF THE INVENTION

A boot cover assembly is disclosed. The boot cover assembly includes a generally cylindrical axially extending can, and a generally conical axially extending boot. The can has a first end, a central portion, and a second end. The boot includes inner and outer surfaces, a first large end, a central portion, a second small end. A portion of the second end of the can and a portion of the first large end of the boot are bonded together to form a coupling region. A portion of the inner surface of the second end of the can is bonded to a mounting face formed on an inner surface of the boot. A distal end of the can is also bonded to a mounting shoulder of the boot such that two surfaces of the can are secured to two surfaces of the boot.

### BRIEF DESCRIPTION OF THE DRAWINGS

Referring now to the drawings, preferred illustrative embodiments are shown in detail. Although the drawings represent some embodiments, the drawings are not necessarily to scale and certain features may be exaggerated, removed, or partially sectioned to better illustrate and explain the present disclosure. Further, the embodiments set forth herein are not intended to be exhaustive or otherwise limit or restrict the claims to the precise forms and configurations shown in the drawings and disclosed in the following detailed description:

FIG. 1 is a cross-sectional view of a prior art constant velocity joint with a boot cover assembly.

FIG. 2 is an enlarged image of a distorted prior art boot;

FIG. 3 is a cross-sectional view of a constant velocity joint boot cover assembly in accordance with an embodiment of the present disclosure; and

FIG. 3A is an enlarged cross sectional view of a portion of the constant velocity joint boot cover assembly of FIG. 3.

### DETAILED DESCRIPTION

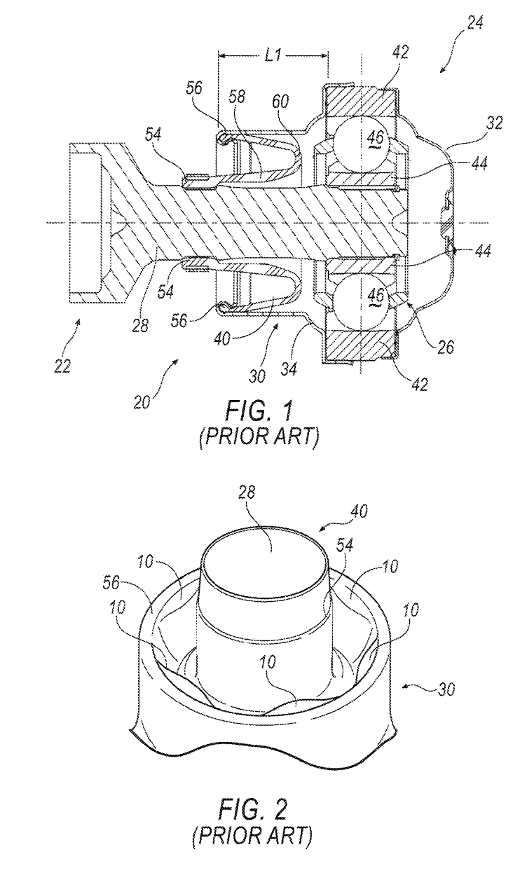

FIG. 1 illustrates a prior art constant velocity joint (CVJ) 20. CVJ 20 includes a driven end 22 and a driving end 24. CVJ 20 further includes a joint assembly 26 coupled to a shaft 28 with a boot cover assembly 30 connected therebetween. CVJ 20 further includes a grease cover 32 that seals the driving end 24. Boot cover assembly 30 includes a metal can 34 and a flexible boot 40. A portion of metal can 34 is crimped onto boot 40 for attachment thereto. Boot cover assembly 30 protects the moving parts of CVJ 20 during operation. Joint assembly 26 includes a first rotational member 42, a second rotational member 44, and a plurality of balls 46. Shaft 28 is splined to second rotational member 44 to allow axial movement there between. Metal can 34 has an axial length L1 that is defined by the axial distance that metal can 34 extends from the first rotational member 42 to the crimped attachment of metal can 34 to boot 40.

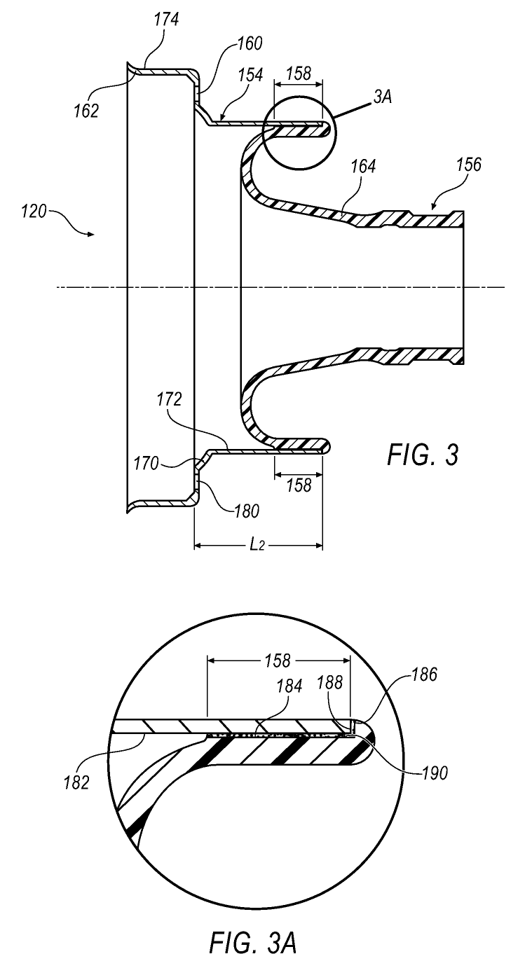

With continual reference to FIG. 1 and specific reference to FIG. 2, the prior art boot 40 includes a contoured body of revolution defined by a small end 54, a large end 56, a middle portion 58, and a curved lobe portion 60. As illustrated in FIG. 1, small end 54 is coupled to shaft 28 and large end 56 is crimped to metal can 34. Metal can 34 is, in turn, coupled to first rotational member 42. Small end 54 is coupled to shaft 28 with a conventional type of hose clamp connector.

FIG. 2 illustrates prior art boot 40 of boot cover assembly 30 after deformation bulging 10 has occurred in an area below where large end 56 of boot 40 is crimped to the metal can 34. The deformation bulging 10 is caused by rotational forces creating pressures capable of fatiguing and destroying the boot 40 of assembly 20.

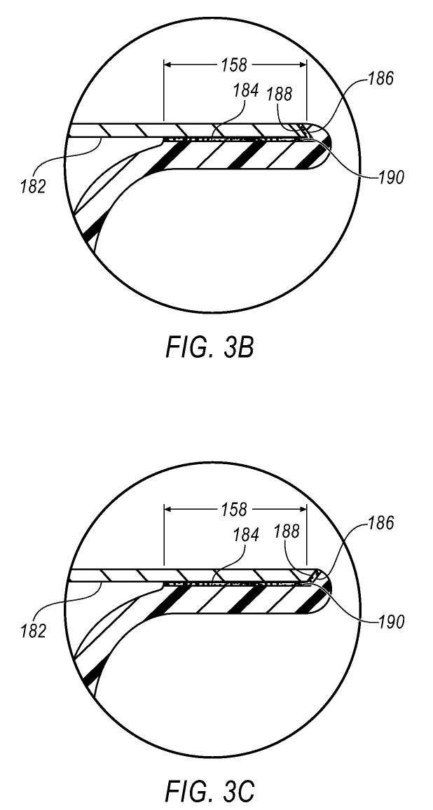

FIG. 3 illustrates an embodiment of a boot cover assembly 120 that serves to protect moving parts of a joint similar to FIG. 1. However, unlike the prior art boot cover assembly 30, boot cover assembly 120 does not include a traditional crimped end at the large end of the boot. Boot cover assembly 120 includes a can portion 154, a boot portion 156, and a coupling region 158.

Can portion 154 is formed of a first substantially rigid material 162, and boot portion 156 is formed of a second substantially flexible material 164, as discussed below. A physical and/or chemical bond occurs at coupling region 158. In one representative embodiment, the bond in the coupling region 158 may be achieved by a two-step adhesive process (to be explained below in greater detail). Other processes for forming the coupling region 158 are also contemplated, such as simply molding boot portion 156 to can portion 154.

Can portion 154 includes a sealing portion 160 that forms a mounting face for a first rotational member (e.g., 42 in FIG. 1). Can portion 154 further includes a radially extending annular face 170, and an axially extending cylindrical body 172 that extends between the annular face 170 and coupling region 158. Cylindrical body 172 has an axial length L2 that is defined by the distance that can portion 154 extends from the mounting face of sealing portion 160 to a distal end of coupling region 158.

Can portion 154 further includes an axially extending lip 174. Can portion 154 may also includes apertures 180 to allow fasteners (not shown) to directly fasten can portion 154 to a first rotational member.

Referring to FIG. 3A, coupling region 158 is formed by a portion of can portion 154 and a portion of boot portion 156. More specifically, boot portion 156 includes a mounting face 184 on a proximal end thereof. An upwardly extending lip forms a mounting shoulder 186. A distal end 188 of can portion 154 is positioned adjacent mounting shoulder 186 and an interior surface 182 of can portion 154 is positioned adjacent mounting face 184.

In one embodiment, the upwardly extending lip is oriented so as to be generally perpendicular to the mounting face 184, such that mounting shoulder 186 and mounting face 184 forms a generally right angle, as shown in FIG. 3A. However, it is also contemplated that the upwardly extending lip may be angled with respect to mounting face 184. For example, the upwardly extending lip may be angled outwardly towards a distal end of boot 156 such that an angle between mounting face 184 and mounting shoulder 186 is greater than 90°. Further, the upwardly extending lip may also be angled inwardly and away from a distal end of boot 156 such that an angle between mounting face 184 and mounting shoulder 186 is less than 90°.

Distal end 188 of can portion 154 is shown in FIG. 3A. In one embodiment, distal end 188 is oriented to generally correspond to mounting shoulder 186. For example, in the embodiment illustrated in FIG. 3A, distal end 188 forms a generally 90° angle with bottom surface 182. In those embodiments where the upwardly extending lip that forms mounting shoulder 186 is angled, distal end 188 may also be angled in a corresponding manner to provide a mating engagement.

It is also contemplated that distal end 188 and mounting shoulder 186 are not correspondingly oriented. In such instances, extra adhesive material may be employed to fill any gaps resulting from a non-corresponding orientation.

Coupling region 158 further includes an adhesive 190 that is positioned between bottom portion 182 and mounting surface 184, as well as distal end 188 and mounting shoulder 186. Adhesive 190 serves to physically and/or chemically bond can portion 154 to boot portion 156 along two surfaces, thereby providing improved resistance to decoupling stresses and forces than the prior art crimped connections.

Coupling region 158 may also be employed for all types of boots by limiting the length of coupling region 158 to a predetermined length that will permit full joint functionality. While an acceptable range of lengths for any given type boot may be determined by FEA analysis, taking into consideration other such factors such as joint type, maximum angle, operating angle and plunge capacity (if applicable), it is contemplated that a suitable range for the length of coupling region 158 is about 5-50 mm. Due to the configuration of coupling region 158, boot cover assembly 120 is less susceptible to deformation bulging (as illustrated in FIG. 2), as grease cannot penetrate between boot portion 156 and can portion 154.

Boot portion 156 may be formed by injection molding. In one embodiment a two-step adhesive process is utilized to form coupling region 158. In this example, during the molding process for boot portion 156, a mold (not shown) is prepared for injection with can portion 154 placed in the mold. The two-step adhesive process may be performed at this stage by pre-treating bottom surface 182 of can portion 154 and distal end 186 that forms part of coupling region 158 with a first adhesive or primer. After a predetermined time period to allow the primer to cure, approximately 2 minutes, a second adhesive or top coat material is added to the coupling region 158 to adhere can portion 154 to boot portion 156 during the molding process. The primer adheres to can portion 154. The top coat material adheres to the primer. The flexible boot material 164 is injected into the mold and is allowed to cure with a portion of the boot material being adhered to the top coat material. Using this process, boot portion 156, the primer, top coat material and can portion 154 cooperate to form coupling region 158, thereby adhering boot portion 156 to the pre-manufactured can portion 154 at two surfaces, as explained above.

Can portion 154 is constructed preferably of a relatively rigid material, and may be selected from the family of thermoplastic polyester resins, a resin and filler to increase rigidity and strength or a metal capable of being formed to the desired axial rotating shape.

Boot portion 156 is constructed preferably of a substantially flexible material 164, and may be plastic or any elastomer, such as rubber, silicone, or thermoplastic elastomer (TPE). Flexible material 164 has a hardness value in the range of about 55-75 Shore A or about 35-55 Shore D. In one embodiment, flexible material 164 has a hardness of about 40-44 Shore D. Materials that are specifically compatible with a typical boot cover assembly 120 environment are relatively rigid thermoplastic polyesters due to the desirable bonding formed in coupling region 158 during the molding process.

The adhesive as well as the pressures induced by the molding process ensures that the coupling region 158 provides a reliable bond between can portion 154 and boot portion 156. The pressures of the molding process, the flow of resins in the mold and the adhesives provide for a coupling region 158 that is both a chemical bond, as well as a physical bond. The coupling region 158 forms a bond between can portion 154 and boot portion 156 that is selectively in shear, compression and tension during operation of joint 20. These shear, compressive, and tensile forces are the result of at least deflection within boot cover assembly 120 due to torsional and rotational movement of joint 20.

The connection between can portion 154 and boot portion 156 provides improved resistance to decoupling stresses and forces than the prior art crimped connection. That is, values of stresses, forces, and deflection that can be tolerated in coupling region 158 of boot cover assembly 120 may not be tolerated in the crimped connection of boot cover assembly 30. Thus, the coupling region 158 may accept greater articulation and axial movement within joint 120.

The present invention has been particularly shown and described with reference to the foregoing embodiment, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

1. A boot cover assembly comprising:
a generally cylindrical axially extending can having a first end, a central portion, and a second end;
a generally conical axially extending boot having inner and outer surfaces, a first large end, a central portion, a second small end;
wherein a portion of the second end of the can and a portion of the first large end of the boot are bonded together to form a coupling region, such that a portion of the inner surface of the second end of the can is bonded to a mounting face of the boot and a distal end of the can is bonded to a mounting shoulder of the boot such that two surfaces of the can are secured to two surfaces of the boot.

2. The boot cover assembly of claim 1, wherein the portion of the second end of the can and the first large end of the boot are bonded together by adhesive.

3. The boot cover assembly of claim 2, wherein two different adhesives are used to bond together the second end of the can and the first large end of the boot, whereby the first adhesive is applied to the can and the second adhesive is applied between the first adhesive and the boot.

4. The boot cover assembly of 1, wherein the boot is formed of a flexible elastomeric material.

5. The boot cover assembly of claim 1, wherein the boot is an internal rolling diaphragm boot or an external rolling diaphragm boot.

6. The boot cover assembly of claim 1, wherein the mounting shoulder is defined by an upwardly extending lip on the first large end of the boot.

7. The boot cover assembly of claim 6, wherein the upwardly extending lip is generally perpendicular to the mounting surface of the boot.

8. The boot cover assembly of claim 6, wherein the upwardly extending lip is angled with respect to the mounting surface of the boot.

9. The boot cover assembly of claim 8, wherein the upwardly extending lip is angled outwardly toward a distal end of the boot such that an angle formed between the mounting surface and the mounting shoulder is greater than 90°.

10. The boot cover assembly of claim 8, wherein the upwardly extending lip is angled inwardly toward a distal end of the boot such that an angle formed between the mounting surface and the mounting shoulder is less than 90°.

11. The boot cover assembly of claim 1, wherein the distal end of the can is oriented so as to generally corresponds to the orientation of the mounting shoulder.

12. The boot cover assembly of claim 1, wherein the coupling region has a length in the range of about 5-50 mm.

13. A sealing assembly comprising:
a generally rigid cylindrical axially extending can having inner and outer surfaces, an axially extending first large end, a central portion, and a second small end protruding axially away from the central portion and terminating in a distal end;
a generally flexible conical axially extending diaphragm boot having a large diameter end, a central portion and a small diameter end;
wherein a portion of the second small end of the can and a portion of the large diameter end of the boot are bonded together to form a coupling region, such that a surface of the second small end of the can is bonded to a mounting face positioned on the large diameter end of the boot and a distal end of the can is bonded to a mounting shoulder of the boot by adhesive such that two surfaces of the can are secured to two surfaces of the boot.

14. The sealing assembly of claim 13, wherein two different adhesives are used to bond together the second end of the can and the first large end of the boot, whereby the first adhesive is applied to the can and the second adhesive is applied between the first adhesive and the boot.

15. The sealing assembly of claim 13, wherein the diaphragm boot is an internal rolling diaphragm boot or an external rolling diaphragm boot.

16. The sealing assembly of claim 13, wherein the coupling region has a length in the range of about 5-50 mm.
